(19) United States
(12) Patent Application Publication
(10) Pub. No.: US 2021/0241046 A1
(43) Pub. Date: Aug. 5, 2021

(54) COMPOSITIONS AND METHODS FOR CANCER DETECTION AND CLASSIFICATION USING NEURAL NETWORKS

(71) Applicant: UNIVERSITY OF NORTH TEXAS, Denton, TX (US)

(72) Inventors: Rajeev AZAD, Corinth, TX (US); Steven GORE, Denton, TX (US)

(21) Appl. No.: 17/105,204

(22) Filed: Nov. 25, 2020

Related U.S. Application Data
(60) Provisional application No. 62/940,371, filed on Nov. 26, 2019.

(51) Int. Cl. G06K 9/62; G06N 3/04; G06K 9/66

(52) U.S. Cl. CPC G06K 9/6269; G06K 9/66; G06N 3/0454

(57) ABSTRACT

In alternative embodiments, provided are computer-implemented methods using neural networks for detecting and classifying cancers. Also provided are methods for diagnosing a cancer comprising use of a computer-implemented method for detecting and classifying cancers as provided herein. Also provided are methods for treating a cancer comprising use of a computer-implemented method for detecting and classifying cancers as provided herein.

### RELATED APPLICATIONS

This U.S. Utility Patent Application claims the benefit of priority under 35 U.S.C. § 119(e) of U.S. Provisional Application Ser. No. (USSN) 62/940,371, filed Nov. 26, 2019. The aforementioned application is expressly incorporated herein by reference in its entirety and for all purposes.

### TECHNICAL FIELD

This invention generally relates to artificial intelligence and cancer detection and diagnosis. In alternative embodiments, provided are compositions, including products of manufacture and kits, and methods, using neural networks for detecting and classifying cancers using neural networks. Also provided are methods for diagnosing a cancer comprising use of a computer-implemented method for detecting and classifying cancers as provided herein. Also provided are methods for treating a cancer comprising use of a computer-implemented method for detecting and classifying cancers as provided herein.

### BACKGROUND

When discovered in early stages, a cancer has little to no chance to spread, whereas the later stage cancers are more likely to break through the tissue barriers and metastasize to distant sites in the body. A patient's prognosis is strongly linked to the progression or stage at the time of detection.^{(1,2)} Cancer screening has improved over the past 50 years but this progress has relied on the development of individual biomarkers for each cancer type making the process slow and costly⁽³⁻⁶⁾. There is a pressing need for new diagnostic developments with a focus on broad spectrum tests that rely on more information rich biomarkers rather than single low information biomarkers. Such a test could result in detection of more cancer types, including the rare cancers that are not typically the focus of individual biomarker research.

### SUMMARY

In alternative embodiments, provided are methods, including computer-implemented methods, for detecting and classifying cancers comprising use of methods as provided herein.

In alternative embodiments, provide are computer-implemented methods for detecting and classifying cancers comprising: a computer-implemented method comprising a subset of, substantially all, or all of the steps as set forth in the flow chart of FIG. 10.

In alternative embodiments, provided are computer program products for processing data, the computer program product comprising: computer-executable logic contained on a computer-readable medium (optionally a non-transitory computer-readable medium) and configured for causing the following computer-executed steps to occur: executing the computer-implemented method as provided herein.

In alternative embodiments, provided are Graphical User Interface (GUI) computer program products comprising: program instructions for running, processing and/or implementing: (a) a computer-implemented method as provided herein; (b) a computer program product as provided herein.

In alternative embodiments, provided are computer systems comprising a processor and a data storage device wherein said data storage device has stored thereon: (a) a computer-implemented method as provided herein; (b) a computer program product as provided herein; (c) a Graphical User Interface (GUI) computer program product as provided herein; or, (d) a combination thereof.

In alternative embodiments, provided are non-transitory memory mediums, or a non-transitory memory medium comprising program instructions for running, processing and/or implementing: (a) a computer-implemented method as provided herein; (b) a computer program product as provided herein; (c) a Graphical User Interface (GUI) computer program product as provided herein; (d) a computer system as provided herein; or (e) a combination thereof.

In alternative embodiments, provided are non-transitory computer readable medium storing an executable program comprising instructions to perform a method as provided herein; or (a) a computer-implemented method as provided herein; (b) a computer program product as provided herein; (c) a Graphical User Interface (GUI) computer program product as provided herein; (d) a computer system as provided herein; or (e) a combination thereof.

In alternative embodiments, provided are methods for diagnosing a cancer comprising use of a computer-implemented method for detecting and classifying cancers as set forth herein. The cancer can be: Adrenocortical carcinoma (ACC), Bladder Urothelial Carcinoma (BLCA), Breast invasive carcinoma (BRCA), Cervical squamous cell carcinoma and endocervical adenocarcinoma (CESC), Cholangiocarcinoma (CHOL), Colon adenocarcinoma (COAD), Lymphoid Neoplasm Diffuse Large B-cell Lymphoma (DLBC), Esophageal carcinoma (ESCA), Glioblastoma multiforme (GBM), Head and Neck squamous cell carcinoma (HNSC), Kidney Chromophobe (KICH), Kidney renal clear cell carcinoma (KIRC), Kidney renal papillary cell carcinoma (KIRP), Acute Myeloid Leukemia (LAML), Chronic Myelogenous Leukemia (LCML), Brain Lower Grade Glioma (LGG), Liver hepatocellular carcinoma (LIHC), Lung adenocarcinoma (LUAD), Lung squamous cell carcinoma (LUSC), Mesothelioma (MESO), Ovarian serous cystadenocarcinoma (OV), Pancreatic adenocarcinoma (PAAD), Pheochromocytoma and Paraganglioma (PCPG), Prostate adenocarcinoma (PRAD), Rectum adenocarcinoma (READ), Sarcoma (SARC), Skin Cutaneous Melanoma (SKCM), Stomach adenocarcinoma (STAD), Testicular Germ Cell Tumors (TGCT), Thyroid carcinoma (THCA), Thymoma (THYM), Uterine Corpus Endometrial Carcinoma (UCEC), Uterine Carcinosarcoma (UCS), or Uveal Melanoma (UVM).

In alternative embodiments, provided are methods for treating a cancer comprising use of a computer-implemented method for detecting and classifying cancers as set forth herein, wherein the method comprises: (a) using the computer-implemented method for detecting and classifying a cancer in an individual in need thereof, and (b) treating the detected and classified cancer. The cancer can be: Adrenocortical carcinoma (ACC), Bladder Urothelial Carcinoma (BLCA), Breast invasive carcinoma (BRCA), Cervical squamous cell carcinoma and endocervical adenocarcinoma (CESC), Cholangiocarcinoma (CHOL), Colon adenocarcinoma (COAD), Lymphoid Neoplasm Diffuse Large B-cell Lymphoma (DLBC), Esophageal carcinoma (ESCA), Glioblastoma multiforme (GBM), Head and Neck squamous cell carcinoma (HNSC), Kidney Chromophobe (KICH), Kidney renal clear cell carcinoma (KIRC), Kidney renal papillary cell carcinoma (KIRP), Acute Myeloid Leukemia (LAML), Chronic Myelogenous Leukemia (LCML), Brain Lower Grade Glioma (LGG), Liver hepatocellular carcinoma (LIHC), Lung adenocarcinoma (LUAD), Lung squamous cell carcinoma (LUSC), Mesothelioma (MESO), Ovarian serous cystadenocarcinoma (OV), Pancreatic adenocarcinoma (PAAD), Pheochromocytoma and Paraganglioma (PCPG), Prostate adenocarcinoma (PRAD), Rectum adenocarcinoma (READ), Sarcoma (SARC), Skin Cutaneous Melanoma (SKCM), Stomach adenocarcinoma (STAD), Testicular Germ Cell Tumors (TGCT), Thyroid carcinoma (THCA), Thymoma (THYM), Uterine Corpus Endometrial Carcinoma (UCEC), Uterine Carcinosarcoma (UCS), or Uveal Melanoma (UVM).

The details of one or more exemplary embodiments of the invention are set forth in the accompanying drawings and the description below. Other features, objects, and advantages of the invention will be apparent from the description and drawings, and from the claims.

All publications, patents, patent applications cited herein are hereby expressly incorporated by reference in their entireties for all purposes.

### DESCRIPTION OF DRAWINGS

The patent or application file contains at least one drawing executed in color. Copies of this patent or patent application publication with color drawing(s) will be provided by the Office upon request and payment of the necessary fee.

The drawings set forth herein are illustrative of exemplary embodiments provided herein and are not meant to limit the scope of the invention as encompassed by the claims.

FIG. 1 graphically illustrates a graphic visualization of different cell states on a landscape with peaks and valleys, where stem cell states are located atop mountain peaks and their differentiating progenies follow well defined but shallow pathways toward their destination cell states once a developmental program is complete.

FIG. 2 schematically illustrates how methylation samples were downloaded from The Cancer Genome Atlas (TCGA) GDC portal, showing that breast, colon, kidney, liver, lung, prostate and ovary were chosen for procuring the respective methylation data based on two criteria, as described in Example 1, below.

FIG. 3 illustrates the clustering of cancers based on feature importance scores, and performance of an exemplary neural network method (also called CancerNet) over 19 classes of cancer, and performance was assessed using the accuracy metric F-measure, as discussed in detail in Example 2, below.

FIG. 4 showing the latent space distribution of test sample, as discussed in detail in Example 2, below.

FIG. 5 illustrates the renal subtype of latent space distribution, as discussed in detail in Example 2, below.

FIG. 6A illustrates gastric adeno body sites; and, FIG. 6B illustrates gastric adeno hypomethylation status, as discussed in detail in Example 2, below.

FIG. 7A illustrates squamous HPV, and FIG. 7B illustrates squamous smoking samples, as discussed in detail in Example 2, below.

FIG. 8 illustrates metastatic performance, as discussed in detail in Example 2, below.

FIG. 9 illustrates a diagram of the architecture of an exemplary method (CancerNet) as provided herein, as discussed in detail in Example 2, below.

FIG. 10 illustrates a flow diagram of an exemplary method (CancerNet) as provided herein, as discussed in detail in Example 1 and Example 2, below

FIG. 11A illustrates a flow diagram showing dense feedforward steps of an exemplary method as provided herein; FIG. 11B illustrates a flow diagram showing a probabilistic layer steps of an exemplary method as provided herein.

The patent or application file contains at least one drawing executed in color. Copies of this patent or patent application publication with color drawing(s) will be provided by the Office upon request and payment of the necessary fee.

Like reference symbols in the various drawings indicate like elements.

### DETAILED DESCRIPTION

In alternative embodiments, provided are compositions, including products of manufacture and kits, and methods, using neural networks for detecting and classifying cancers using neural networks.

In alternative embodiments, provided are compositions and methods using circulating tumor DNA (ctDNA) found in blood samples as a pan-cancer biomarker.^{(7),(8)}. Though DNA alterations such as SNPs and copy number alterations may provide some information about the presence and nature of cancer, this is not the only source of relevant information carried in ctDNA. Methylation has also been shown to be significantly altered in many cancers and persists on ctDNA⁽⁵⁻¹³⁾.

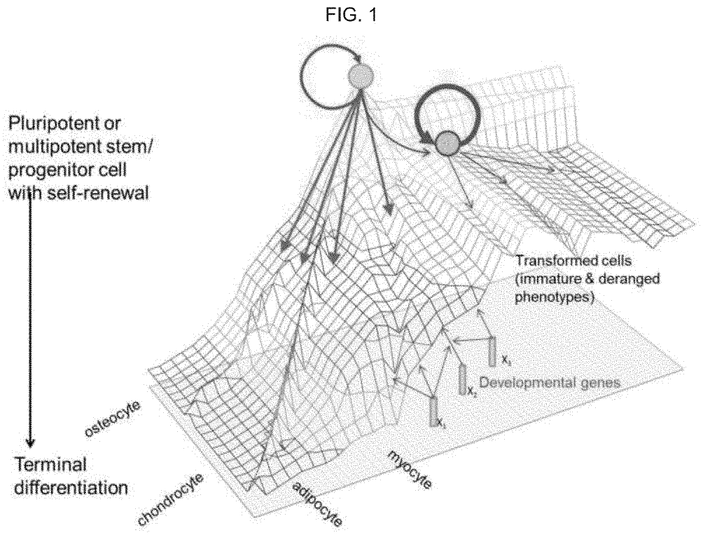

Cancer has been hypothesized to exist on an environment-(epi)genetic landscape where cells arrive in cancerous states through some combination of environmental, genetic and/or epigenetic alterations. Different cell states could be visualized on such a landscape with peaks and valleys (FIG. 1), where stem cell states are located atop mountain peaks and their differentiating progenies follow well defined but shallow pathways toward their destination cell states once a developmental program is complete. Carcinogenic changes, whether genetic, epigenetic, environmental or a combination thereof, alters this landscape by creating new valleys and the paths leading to them, allowing the cells to arrive in aberrant states. With this abstraction for visualization, such a landscape is the logical choice for mapping cell states due to it being the interface of genetics and environment⁽³¹⁾.

Here, a cell state is defined as the suite of expressed or potentially expressed genes in a given cell, which is being measured by the methylation state of their promoters. Approximately 60% of all genes in humans are found in genomic regions dense with CpG's called CpG islands. The CpG dinucleotide is the primary target of the methylation machinery. CpG island promoters that have higher levels of methylation are not accessible and the genes they regulate are therefore not expressed. The determination of a CpG island as being influential to a cancer is determined by the gene expression being governed by the island and the state the cell is already in. By extension the combination of CpG islands that influences a cancer is determined by the interactions of the genes they influence and the way alterations in the expression of those genes affects the cell state. This was established by several recent studies, including the finding that cancers are typically globally hypomethylated with hyper methylation occurring in tumor suppressor genes. It is important to note that cancers which arise in different tissues or from different cell types may display different CpG signatures. Not all gene products interact and those that do tend to arrange themselves into clusters of varying structural complexity.

A number of recent studies have attempted to exploit DNA methylation to detect cancer.^{(14,15,16,17,18,19,20,21)} Recently a probabilistic method called CANCERLOCATOR™ (CancerLocator™) was developed to perform multiclass classification on multiple tissues of origin in cancer and was specifically focused on methylation in ctDNA.⁽²²⁾. Following this study, another group used a random forest model to classify multiple tissues of origin based on methylation and achieved significantly better results than CancerLocator™. Both of these studies relied heavily on feature selection prior to model training, which may introduce biases and exclude non-linear relationships.

Provided herein is neural network based approach, @name@, for cancer tissue of origin detection. Inherent in @name@ is the capability to denoise the data, resulting in learning of a set of relevant features by the model.

Within the proposed framework for cancel classification is a feed forward autoencoder model to map tumor derived cells and non-tumor derived cells onto a lower dimensional space. Autoencoders are unsupervised models that map samples onto a lower dimensional space, resulting in distributions from which samples may be regenerated⁽²⁹⁾. Generative models have been successful in learning distributions from which text may be translated to pictures, apply alternate settings to pictures, such as changing a picture from day to night or changing its style and in mapping RNAseq data from cancer samples to a latent space.^{(tybalt) 29,30,31)}.

Described herein is an exemplary neural network based framework for cancer classification and present a comparative assessment of the performance across 7 tissue types using data from the full suite of CpG islands.

### Products of Manufacture and Kits

Provided are products of manufacture and kits for practicing methods as provided herein; and optionally, products of manufacture and kits can further comprise instructions for practicing methods as provided herein.

### Computers and Computer Systems

Systems and methods as provided herein use apparatus such as computers and storage memory systems for performing the operations as provided herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays used to practice systems and methods as provided herein are not inherently related to any particular computer or other apparatus. Various general-purpose systems may be used with programs in accordance with the teachings herein, or it may prove convenient to construct a more specialized apparatus to perform the method steps. The structure for a variety of these systems will appear from the description provided herein. In addition, embodiments provided herein are not described with reference to any particular programming language. It will be appreciated that a variety of programming languages may be used to implement and practice methods and systems as described herein.

In alternative embodiments, data generated and processed by components of systems and methods as provided herein, include generated data and programs used to practice embodiments as provided herein, are stored and processed using a machine-readable medium, which can includes any mechanism for storing or transmitting information in a form readable by a machine, for example, a computer. For example, a machine-readable medium includes a machine-readable storage medium (for example, read only memory (“ROM”), random access memory (“RAM”), magnetic disk storage media, optical storage media, flash memory devices, etc.), a machine-readable transmission medium (electrical, optical, acoustical or other form of propagated signals, for example, carrier waves, infrared signals, digital signals, and the like.

In alternative embodiments, programs used to process methods and/or systems as provide herein are cloud-based and use wireless systems to communicate (for example, device-to-device (D2D) connectability) with a user (for example, an individual being treated using systems or methods as provided herein) and/or an operator (for example, a person monitoring and/or administering methods or systems as provided herein as they are being practiced, for example, as described in U.S. Pat. No. 10,834,769, which teaches methods by one or more processors for managing a wireless communication network and device-to-device (D2D) connectability.

In alternative embodiments, systems or methods as provided herein use cloud computing to enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a user or manager of systems or methods as provided herein.

In alternative embodiments, provided herein is a non-transitory, machine-(computer-) readable medium, comprising executable instructions that, when executed by a processing system including a processor, facilitate performance of operations, the operations comprising a program used to practice methods or systems as provided herein.

In alternative embodiments, systems and methods as provided herein use handheld devices and/or Bluetooth transmissions to practice embodiments as provided herein, for example, as described in U.S. Pat. No. 10,834,764.

Any of the above aspects and embodiments can be combined with any other aspect or embodiment as disclosed here in the Summary, Figures and/or Detailed Description sections.

As used in this specification and the claims, the singular forms “a,” “an” and “the” include plural referents unless the context clearly dictates otherwise.

Unless specifically stated or obvious from context, as used herein, the term “or” is understood to be inclusive and covers both “or” and “and”.

Unless specifically stated or obvious from context, as used herein, the term “about” is understood as within a range of normal tolerance in the art, for example within 2 standard deviations of the mean. About (use of the term “about”) can be understood as within 20%, 19%, 18%, 17%, 16%, 15%, 14%, 13%, 12% 11%, 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless specifically stated or obvious from context, as used herein, the terms “substantially all”, “substantially most of”, “substantially all of” or “majority of” encompass at least about 90%, 95%, 97%, 98%, 99% or 99.5%, or more of a referenced amount of a composition.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents. Incorporation by reference of these documents, standing alone, should not be construed as an assertion or admission that any portion of the contents of any document is considered to be essential material for satisfying any national or regional statutory disclosure requirement for patent applications. Notwithstanding, the right is reserved for relying upon any of such documents, where appropriate, for providing material deemed essential to the claimed subject matter by an examining authority or court.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, and yet these modifications and improvements are within the scope and spirit of the invention. The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. Thus, the terms and expressions which have been employed are used as terms of description and not of limitation, equivalents of the features shown and described, or portions thereof, are not excluded, and it is recognized that various modifications are possible within the scope of the invention. Embodiments of the invention are set forth in the following claims.

The invention will be further described with reference to the examples described herein; however, it is to be understood that the invention is not limited to such examples.

### EXAMPLES

### Example 1: Using Neural Networks to Diagnose and Classify Cancers

This example demonstrates that methods and compositions as provided herein using the exemplary embodiments are effective and can be used to diagnose cancer. Provided herein is neural network based approach, @name@, for cancer tissue of origin detection. Inherent in @name@ is the capability to denoise the data, resulting in learning of a set of relevant features by the model.

### Methods

### Data Download and Preparation

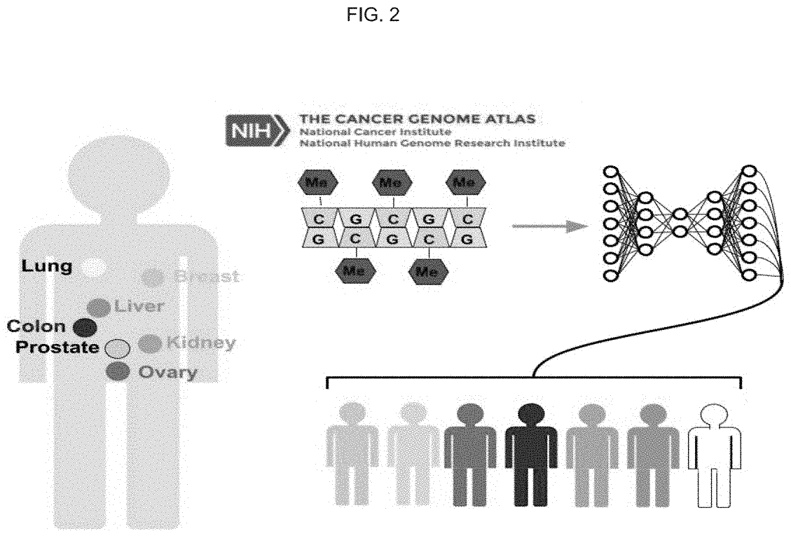

Methylation samples were downloaded from The Cancer Genome Atlas (TCGA) GDC portal, as illustrated in FIG. 2. Breast, colon, kidney, liver, lung, prostate and ovary were chosen for procuring the respective methylation data based on two criteria. First these are hard tumors of the ventral cavity. This was set as a criterion because these tissues have generally good access to the blood, so one would expect ctDNA to be present in the blood. This is important for any future work where ctDNA samples are collected for tissue of origin detection. Second, each tissue has over 1000 samples available in TCGA.

The downloaded methylation data in our local database were screened for those from primary tumors and the matched normal tissues. Two CpG's within 100 base pairs were grouped together. All groups with fewer than 3 CpG's were removed. The mean of @@ for each group was taken and used in training.

We relied on the clustering approach implemented in CancerLocator™ to process the methylation data before inputting to @name@ and other programs⁽³³⁾. Specifically, the methylation data was scanned for Illumina 450 probes that map to within 100 bp of each other, which were then concatenated. This resulted in about 26,000 clusters that map almost exclusively to CpG islands found near transcription binding sites or promoters. For each cluster in a sample, methylation values for were averaged and the resulting methylation data points were used as the input to the programs.

### Neural Network

The neural network algorithm was written in PYTHON™ using the keras package with a tensorflow backbone. All layers were randomly initialized and then trained until convergence. Early stopping was used to limit training time and prevent overfitting. Training was halted if the validation accuracy did not improve for 50 iterations. The network architecture with its hyperparameters are shown in Figures as provided herein.

### Autoencoder

Input layer—CpG Island average values,
Encoder Hidden layer—feed forward, 2000 dimensions, ReLu activation
Encoder HIdden layer 2—feed forward, 200 dimensions, ReLu activation
Latent Layer—feed forward 100 dimensions, ReLu activation
Decoder Hidden Layer—feed forward, 200 dimensions, ReLu Activation
Encoder HIdden layer 2—feed forward, 200 dimensions, ReLu activation
Output—Sigmoid Activation
Optimizer—RMSprop

### Classifier

Input—Autoencoder latent layer, 100 dimensions
Hidden Layer—Feed forward, 50 dimensions, ReLu activation
Output—19 dimensions, sigmoid activation
Loss—categorical crossentropy
Optimizer—RMS prop

The network was trained on a single NVIDIA 1070™ and took around 4 hours to converge. Ten-fold cross validation was performed, as done previously in RF model and CancerLocator™ studies, and comparative assessment made using accuracy metrics described below. For each cross validation run, the network was initialized with the same set of parameter values.

### Model Performance Assessment

Performance was measured using Area under the Receiver Operating Curve (AUC) and f-measure.

### Results

A number of recent studies have attempted to exploit DNA methylation to detect cancer.^{(14,15,16,17,18,19,20,21)} Recently a probabilistic method called CancerLocator™ was developed to perform multiclass classification on multiple tissues of origin in cancer and was specifically focused on methylation in ctDNA.⁽²²⁾. Following this study, another group used a random forest model to classify multiple tissues of origin based on methylation and achieved significantly better results than CancerLocator™. Both of these studies relied heavily on feature selection prior to model training which depended upon distributions of individual CpGs. While effective such methods may introduce biases and exclude non-linear relationships which are present in a complex system such as the cell.

Various other studies have examined the usefulness of other genetic and expression data as cancer signatures with different and sometimes notably good results. RNA based methods perform well when using tissue biopsies as the source material but it is our belief that the signal is significantly degraded when in a cell free setting. We reason that in this setting mRNA from cancerous cells and normal cells are impossible to distinguish unless there are significant changes to the nucleotide sequence or cancer specific isoforms. This creates a critical hurdle in translation of RNA based cancer diagnostic tools. Methylation, on the other hand, may be detected on cell free DNA and has been demonstrated as a viable cell free diagnostic marker for multiple cancer types and their stages (cancer locator).

A variational Autoencoder (VAE) is used for feature detection and dimensionality reduction. The autoencoder uses a feedforward architecture that allows for combinations of features to be considered in a non-linear fashion and mapped to a probabilistic latent space. The latent space mapping is then fed to a two layer feed-forward classifier network that outputs the predicted class. The model is trained by combining the reconstruction loss from the VAE and the classification loss from the classifier. By combining loss the model is forced to maintain a good reconstruction through the generator while separating the samples to optimize classification performance. While the generator of the VAE and the classifier can function somewhat independently of each other the encoder is forced to learn a set of features that satisfy both requirements. In practice, this leads to a strong feature discriminator.

In the random forest and CancerLocator™ models, individual CpG's and CpG islands were considered independently. This reflects the biological reality that altered expression of one gene can influence the balance of the pathway it is a part of. It also holds open the possibility that the network can detect summative alterations in methylation leading to unique profiles with similar phenotypes. This has been hypothesized and, if true, explains some of the variation in response to some therapies although cancers arise from the same tissue.

The importance of high confidence in a positive diagnosis cannot be emphasized for having confidence in a cancer diagnosis. For an unbiased objective assessment of the classifiers on such datasets, we used f-measure (the harmonic mean of recall and precision), which does not include true negatives in its calculation making it robust against large numbers of negative samples. For random forest and CancerLocator™ models, the published confusion matrices were used to calculate f-measure for these studies and compared with those for enough in cancer detection as it spares patients and their families undue emotional and financial burden that may arise from a false positive. To this end care must be taken when choosing a metric or set of metrics to describe the model performance; however, accuracy may mask poor performance in a multiple class classification task if there exist a significant imbalance between negative and positive samples for each class. Often, as the number of classes grows so does the number of negative examples for each class. As the negative class grows a classifier can display high accuracy when all samples are classified as the negative class. In order to make a clinically relevant classifier, minimizing the false positive rate should be prioritized.

CancerNet™ on the same test datasets as in these studies. It is apparent that the published accuracy rates inappropriately emphasized the performance of those models in some cases.

The f-measure range for CancerNet™ is 0.935 to 0.993 with an average of 0.965. In comparison, the random forest model's f-measure ranged from 0.336 to 1 with an average of 0.779. Among 14 different cancer types considered for this assessment, CancerNet™ outperformed RF model on 12 cancer types (Table1), whereas RF model outperformed CancerNet™ in detecting only colorectal and prostate cancers (in terms of overall accuracy defined by the f-measure). @name@ also substantially outperformed CancerLocator™ on all 3 cancer types (Breast, Liver, and Lung) that were considered in the CancerLocator™ study (compare average f-measure of 0.97 for the former with 0.69 for the latter, Table 1).

While the majority of classes have high f measure a few have lower performance. READ, COAD and UCS all had f measures lower than 90%. We investigated the source of this low performance and found that although samples were misclassified they were largely or completely misclassified to classes of highly related cancers, often from the same tissue or with high associated risks.

Although COAD and READ performance was 0.86 and 0.44 respectively when the two classes misclassifications are examined we find that they tend to classify across these two. COAD samples misclassify exclusively to the READ class.

READ misclassify to the COAD class 63.6% of the time and to LUAD 3% of the time. While the distinction between the two cancer types is clinically important for treatment the task of locating the cancer is correct in all but the LUAD classifications for the COAD and READ classes.

The UCS class had an f1 of 0.7. When examining the misclassifications within this class we find that all of the misclassifications are to the other uterine cancer class in the classifier, UCEC. Additionally, the misclassifications of the UCEC class are evenly distributed across BRCA, OV and UCS. Aside from the BRCA class, the uterine and ovarian cancers may be misdiagnosis as it can be difficult to discern the original tissue of these cancers because they can occur on the border between the ovary and uterus. UCEC, OV, BRCA and OV cancers have been shown to have associated risks.

24 datasets were downloaded from ncbi GEO for further analysis of the model. A clinical setting will present situations the model did not see in training. For example, the training of CancerNet™ did not include metastatic tissues.

Two datasets contained metastatic data (one from prostate and one from the uterus). The prostate set contained both normal and metastatic samples. CancerNet™ had an f1 value of 0.933 for metastatic classification and 1 for normal classification. This is a significant improvement from the performance on the validation data. The uterine set contained only metastatic samples and CancerNet™ had an f1 value of 0.915. This demonstrates that is the potential use case of determining whether a secondary tumor is a new primary or metastatic cancer allowing for more informed treatment options.

In the ovarian cancer data set performance was very low due to many or all of the samples being classified as uterine. This is an acceptable result due to the fact that many ovarian cancers originate at where the fallopian tubes meet the ovary so it is not entirely clear which tissue was the tissue of origin. Such a distinction in tissue of origin is not trivial as it can be used to choose more effective treatment and monitoring methods which would lead to improved outcomes. (might be good to look at some of the CPGs it focused on and connect them to known uterine or ovarian cancer genes).

One breast cancer set contained precancer samples and samples from patients who did not develop breast cancer. The classifier did identify the future cancer samples correctly with an f1 of 0.81. It identified non future cancer samples with an f1 of 0.77. Together these numbers provide some small evidence that CancerNet™ could be used for early detection of cancer as well alongside metastatic tissue of origin detection.

Although several datasets took into consideration age one dataset in particular was used to assess age related drift and its rate in normal, neoplastic and cancerous cells. CancerNet™ classified all of the non cancerous samples as normal (correctly) regardless of age. This is in addition to Colon and rectal cancers performing well on the validation set and in other independent datasets. Colorectal cancer is a very active area of research for ctDNA detection, a tool such as CancerNet™ that is capable of high-performance detection of CRC is a vital tool in the pipeline for early CRC detection.

A lung dataset consisting of lung cancer samples and various other lung disease (but non cancerous) samples had poor performance in normal sample classification. It is unclear why this is the case however it may be that in the case of lung cancer CancerNet™ has learned a signature that is not LUAD. There are many instances where incorrectly classified samples where classified as LUAD.

Cosine distance of cluster (get pairwise cosine distance for each mapping of TCGA and cluster them to show how they are close to each other.

DO visualization of latent space (use PCA to reduce dimensions, use top 3 PCA dimensions for visualization) This and the heatmap will be used to visualize the clusters. Do with each additional dataset (this can be done by saving the latent mapping of the datasets and then running them all in the same PCA run).

### Example 2: A Unified Deep Learning Network for Pan-Cancer Diagnostics

This example demonstrates that methods and compositions as provided herein using the exemplary embodiments are effective and can be used to diagnose cancer.

Despite remarkable advances in cancer research, cancer remains one of the leading causes of death worldwide. Early detection of cancer and localization of the tissue of its origin are key to effective treatment modalities, which however has been woefully lacking resulting in poor prognosis and high mortality. Here, we leverage technological advances in machine learning or artificial intelligence to design a novel framework for cancer diagnostics. In contrast to current cancer diagnostic protocols that are invasive and cancer type specific, our proposed framework detects cancers and their tissues of origin using a unified model of cancers encompassing all tumors present in The Cancer Genome Atlas. The exemplary methods as provided herein model exploit the distinctive signatures of different cancers reflected in the respective dysregulated epigenomes, which arise early in carcinogenesis and differ remarkably between different cancer types or subtypes, thus holding a great promise in early cancer detection. Our comprehensive assessment of the proposed model on 34 different cancers demonstrates its ability to detect and classify cancers to a high accuracy (greater than 99% overall). Furthermore, exemplary methods as provided herein distinguish cancers in high risk and low risk patient populations as well as discriminates between age related epigenetic drift signatures and true cancer signatures. Importantly, the exemplary methods as provided herein are also capable of detecting secondary tumors' tissues of origin thus enabling precision diagnosis of metastatic and second primary cancers. Deployed broadly exemplary methods as provided herein can deliver accurate diagnosis for a greatly expanded target patient population in a non-invasive or minimally invasive setting.

Survival rates of cancer patients dramatically improve when diagnosed in early stages as tumors may not have spread yet. However, detection rates in early stages are inconsistent across cancers. As an example, ˜63% of breast cancer cases are diagnosed in stage 1 while only ˜17% lung cancer cases are diagnosed in the same stage¹. This is owing, in part, to the fact that diagnostic development has historically focused on detecting individual cancers. Many cancers are detected only when the symptoms appear, which most often occur in later stages. The need for robust, non-invasive pan-cancer screening has long been felt, however, this has come close to realization only recently thanks to new developments in high-throughput experimental and computational technologies. The development of pan-cancer diagnostics would enable detection of more cancer types, including rare cancers that are not typically the focus of individual biomarker research, thus dramatically improving the prognosis and survival of cancer patients. Such a tool would allow clinicians to diagnose more patients earlier and guide more informed treatment decisions. Additionally, successful application of such a tool to pre-symptomatic patients would necessitate further efforts to locate the tumor to a specific body site with greater resolution. Here, we present a unified cancer diagnostic capable of both, robust cancer diagnosis and tissue of origin detection, for 33 different cancers.

Approximately 60% of genes in humans are found in genomic regions dense with CpG dinucleotides called CpG islands.² These sites may be methylated and the degree of methylation influences expression of downstream genomic regions. Tissue specific patterns of methylation arise through development and limit the possible changes to the cell state during development or carcinogenesis^{3,4}. Methylation has been shown to be significantly altered in many cancers making it promising as a pan-cancer biomarker, and furthermore, as patterns of alteration vary by cancer types or subtypes, methylation is being exploited to distinguish different cancer types or subtypes^{2,5-10}.

High throughput array-based technologies, such as the Illumina HumanMethylation 450 array, provide methylation beta-values which approximate the level of methylation at loci of interest across the human genome (over 450,000 sites within CpG islands and other regions using 450 array). Methylation data has previously been used to successfully develop classifiers for individual cancer types and cancers derived from tissues with common developmental lineages.¹¹⁻¹⁸

Among neural network architectures unsupervised methods have seen growing use in biological data analysis, particularly for dimensionality reduction with high degrees of success¹⁹⁻²³. These methods map data to a latent subspace in a probabilistic manner in order to capture the underlying data structure. Variational autoencoders (VAEs), belonging to this class of methods, have been used as a basis for downstream regression or classification in a host of applications, including methylation or transcriptional data analysis. This is done by passing on the latent mapping of a sample to a classifier such as a support vector machine²⁴.

Whereas the in-tandem use of unsupervised and supervised methods is promising, the practice of using multiple inline models that do not inform on each other suffers from the inability to utilize new information learnt in the downstream tasks. In this case the neural network acts to simply encode a large number of features to be passed to another model. This does not allow for features in the latent space to be modified based on new information gained during classification. Unsupervised methods in neural networks are oriented toward generating realistic inputs. This may be done in an encoder by calculating a loss from the fidelity of the generators output to the input²⁴. In a generative adversarial network this is accomplished by learning a latent space from which the generator can output samples that can cause a discriminator network to output a ‘real’ classification²⁵. While these methods have shown to be powerful it is not entirely clear that their learned features are optimal for a classification setting. The disagreement among the tasks of tandem models may mean that the unsupervised stage may pass suboptimal encodings for the classifier. It is then possible that a model which trains the encoder/generator and classifier at the same time will yield a model in which the natural distribution of the data is retained while also learning the best encoding for a classifier. end-to-end learning method is then preferable as the features can be altered to suit the downstream classification task.

Provided herein is an integrative platform where learning of both the generative (unsupervised) and the classification (supervised) tasks takes place at the same time on a beta-VAE backbone. This hybrid generator/classifier architecture enables learning of discriminative features intrinsic to input data in tandem with producing a robust classifier. Tuned for and trained on cancer tissues of origin and normal/non-cancerous tissues neural network exemplary methods as provided herein, designated “CancerNet”, is currently capable of detecting 34 different cancers. CancerNet was assessed on multiple independent datasets including samples types that were not used in training CancerNet, metastatic and early cancer samples.

### Neural Network Performance

Exemplary methods as provided herein (CancerNet) are based on a novel neural network architecture, named Constrained Classification VAE or CC-VAE (see Methods). CancerNet, parameters were learnt from training data obtained from The Cancer Genome Atlas (TCGA) for 34 different cancers and a normal class. The cancers investigated were Adrenocortical carcinoma (ACC), Bladder Urothelial Carcinoma (BLCA), Breast invasive carcinoma (BRCA), Cervical squamous cell carcinoma and endocervical adenocarcinoma (CESC), Cholangiocarcinoma (CHOL), Colon adenocarcinoma (COAD), Lymphoid Neoplasm Diffuse Large B-cell Lymphoma (DLBC), Esophageal carcinoma (ESCA), Glioblastoma multiforme (GBM), Head and Neck squamous cell carcinoma (HNSC), Kidney Chromophobe (KICH), Kidney renal clear cell carcinoma (KIRC), Kidney renal papillary cell carcinoma (KIRP), Acute Myeloid Leukemia (LAML), Chronic Myelogenous Leukemia (LCML), Brain Lower Grade Glioma (LGG), Liver hepatocellular carcinoma (LIHC), Lung adenocarcinoma (LUAD), Lung squamous cell carcinoma (LUSC), Mesothelioma (MESO), Ovarian serous cystadenocarcinoma (OV), Pancreatic adenocarcinoma (PAAD), Pheochromocytoma and Paraganglioma (PCPG), Prostate adenocarcinoma (PRAD), Rectum adenocarcinoma (READ), Sarcoma (SARC), Skin Cutaneous Melanoma (SKCM), Stomach adenocarcinoma (STAD), Testicular Germ Cell Tumors (TGCT), Thyroid carcinoma (THCA), Thymoma (THYM), Uterine Corpus Endometrial Carcinoma (UCEC), Uterine Carcinosarcoma (UCS), Uveal Melanoma (UVM).

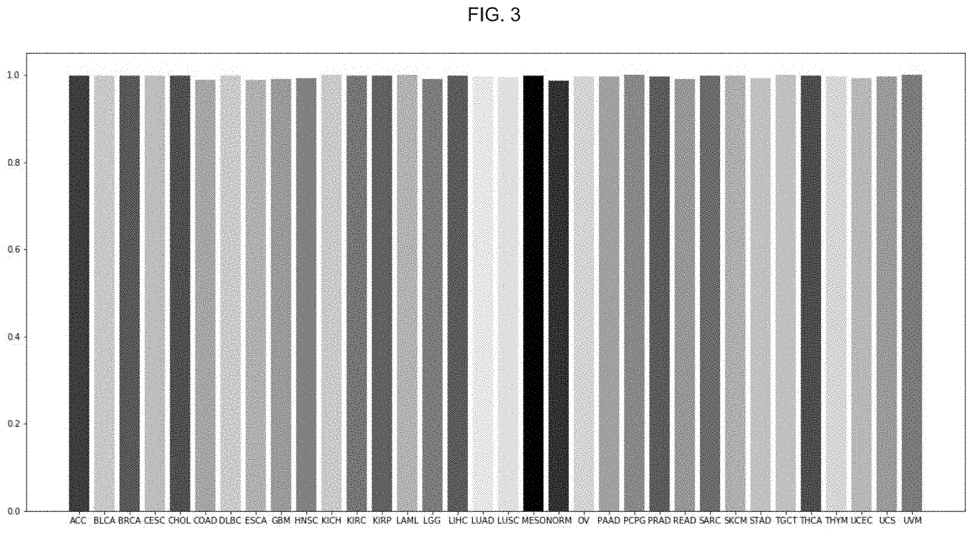

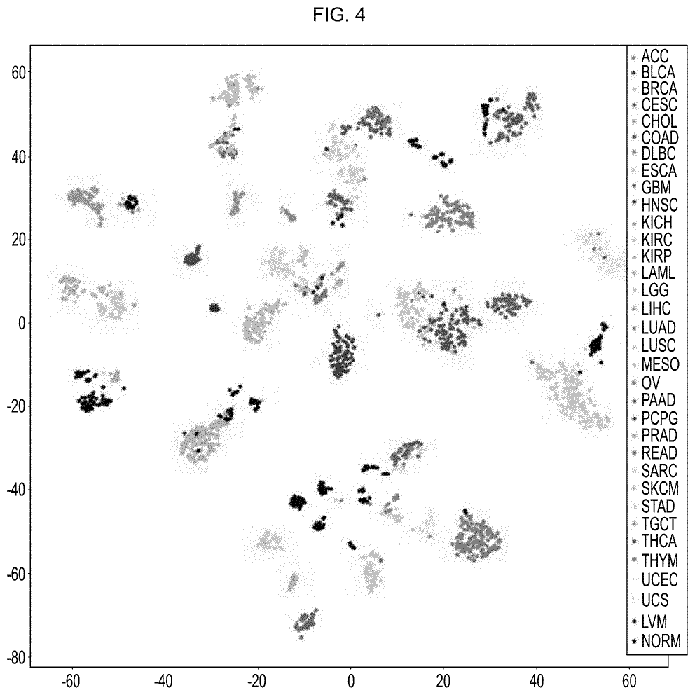

The overall accuracy of CancerNet, as quantified through F-measure, is approximately 99.6% (FIG. 3). Many of the misclassifications occurred among cancers from the same or similar organs and tissues classes that share developmental lineages. Where this did not hold true, we found a pattern of misclassifying among adenocarcinomas and squamous carcinomas @@suppfig. Examination of the latent layer shows that misclassifications occurred among closely neighboring classes or for individual samples of a class that are singletons very far from the rest of their class (FIG. 4).

### Latent Space Evaluation

We confirmed that the latent space of CancerNet maintains the natural distribution of the sample data by comparing it to the latent space generated through a multi-omic clustering algorithm in a flagship paper form TCGA¹⁸. The latent space of CancerNet shows high concordance with the latent space of TCGA data presented in Hoadley K A, Yau C, Hinoue T, et al (FIG. 4). Similar to that latent space, we also demonstrate that tissue of origin and position in a specific organ dominate our own latent space @@fig (latent space). We also show similar distributions of various subtypes of cancers. In all cases stage did not seem to play a significant role in sample position in the latent space. Due to the use of only methylation data some sample statuses do not show significance in separating samples in CancerNet. We also find that rare cancers and rare cancer subtypes form distinct clusters.

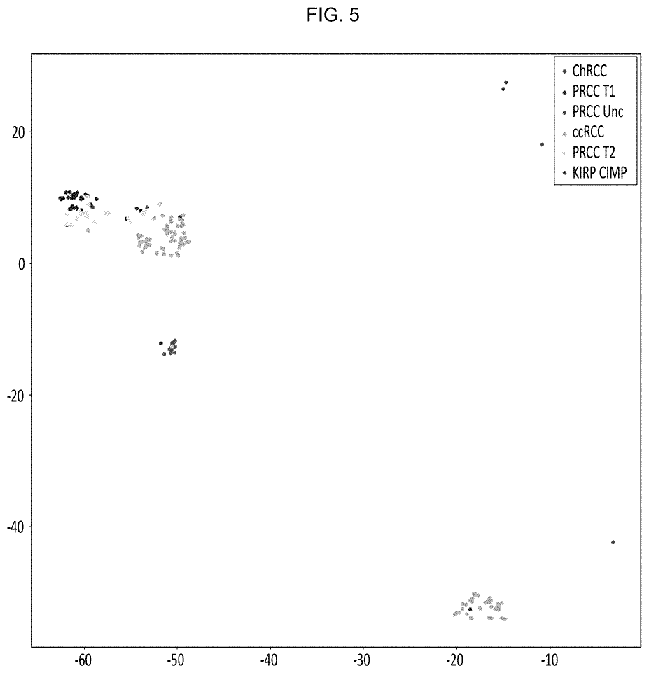

Renal cancers (KIRP, KICH & KIRP) are distributed into 3 clusters (FIG. 5) that are very similar to those described in Hoadley K A, Yau C, Hinoue T, et al . The largest consisting of two bulbs connected by a streak (FIG. 5). One bulb is primarily composed of papillary renal clear cell type1 (PRCC T1) with type 2 (PRCC T2) connecting to the second bulb which is composed of clear cell renal cell carcinoma (ccRCC) (FIG. 5). Two other clusters are primarily composed of ccRCC and chromophobe Renal Cell Carcinoma (chRCC) (FIG. 5), a rare subtype of renal cell carcinomas (RCC) found in only 5% of all renal cancer patients that has a distinct etiology²⁶. The presence of this RCC subtype as a distinct cluster is encouraging as it could indicate the presence of detectable and therapeutically important features present in the network. Among renal cancers gender also showed a distinct separation.

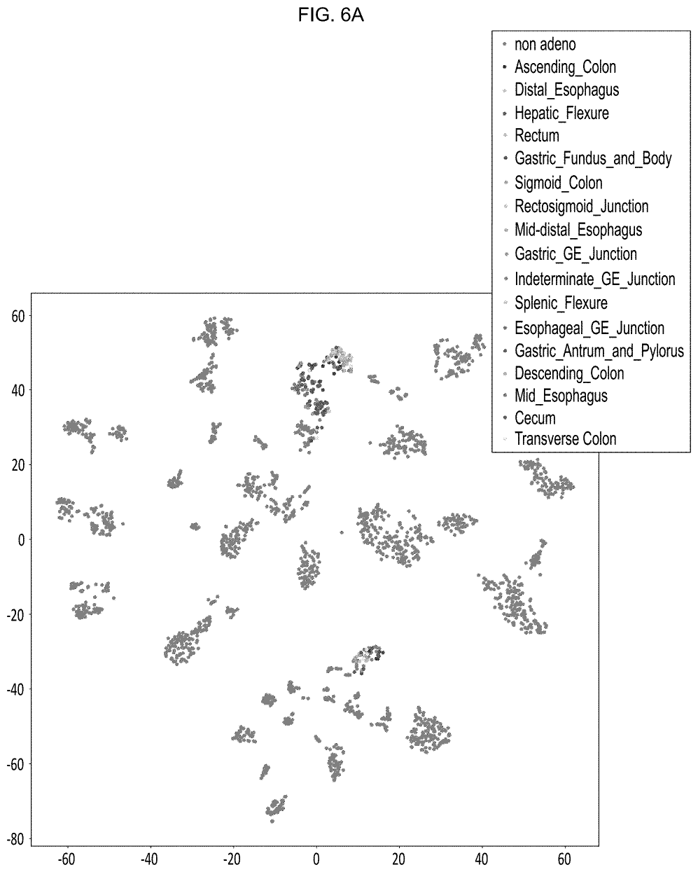

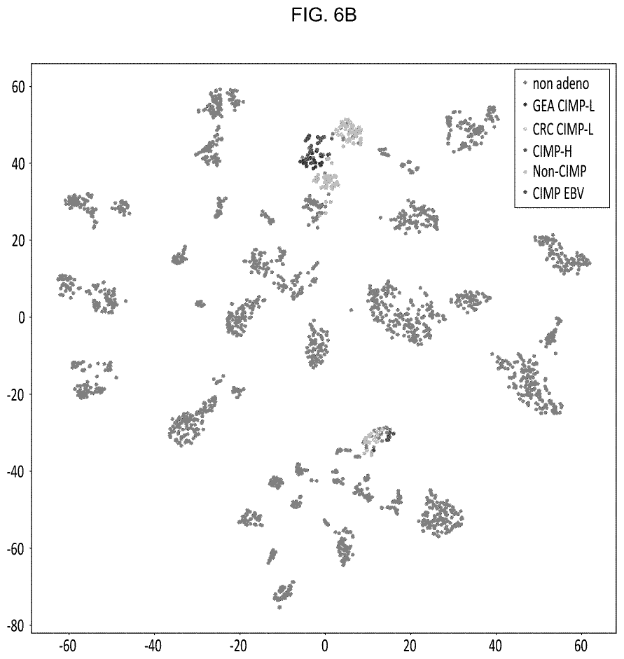

Gastrointestinal adenocarcinomas samples arrange in a similar fashion to the latent space of in Hoadley K A, Yau C, Hinoue T, et al. Samples form several clusters with one cluster distantly separated from the other samples (FIG. 6A-B). Esophageal samples are split among the larger gastrointestinal cluster and a cluster of HNSC. Gastrointestinal adenocarcinomas show strong organ site signatures (FIG. 6A) and are best explained by hypomethylation status (FIG. 6B). Groupings correspond to cPg island methylator (CIMP) status. Non-CIMP, separates from CIMP-H and CIMP-L. STAD and ESCA group together with CIMP-H and gastroesophogeal (GEA) CIMP-L status respectively. Epstein-Barr positive samples occupy their own cluster. Similarly, molecular subtype follows the same pattern as in in Hoadley K A, Yau C, Hinoue T, et al (figure b).

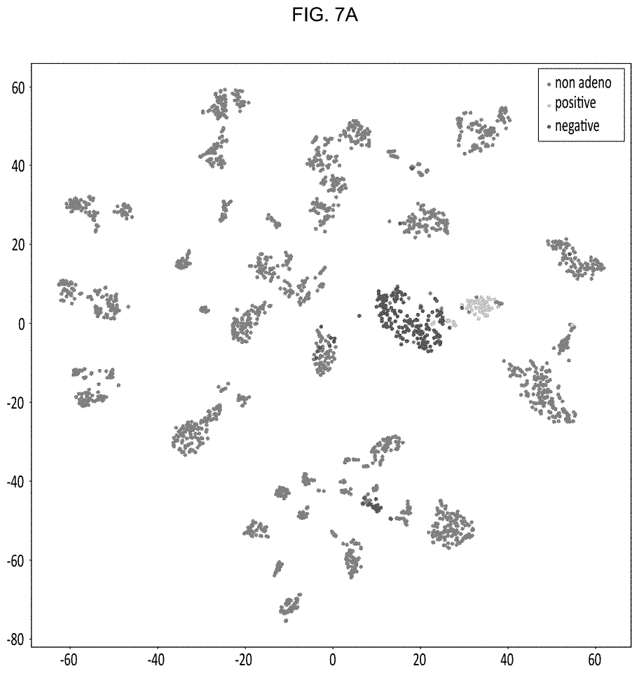

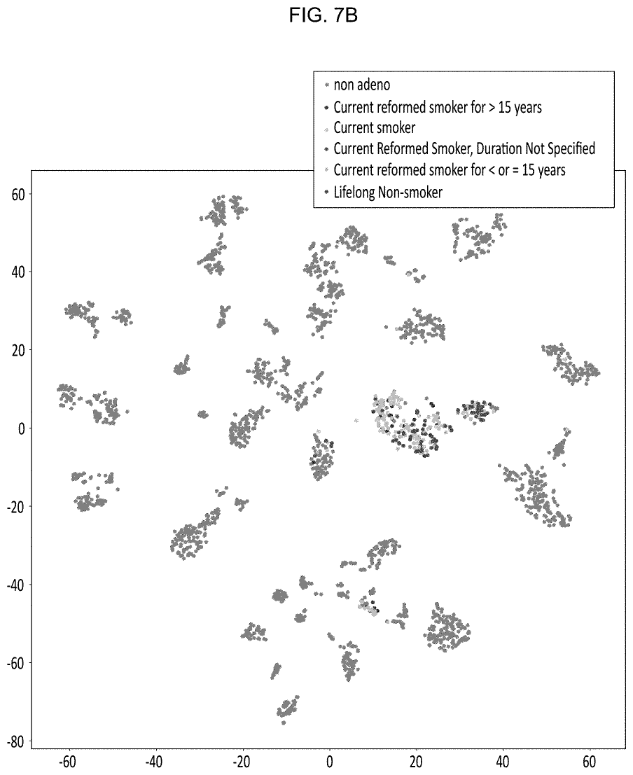

Squamous cell carcinomas (CESC, ESCA, HNSC & LUSC) show strong separation by HPV status, which is in concordance with Campbell J D, Yau C, Bowlby R, et al²⁷. However CancerNet did not show sensitivity to smoking status (FIG. 7).

### Validation

When trained on a narrow range of data neural networks may catastrophically fail on unseen conditions; these models are said to be brittle. To assess how brittle CancerNet is, we evaluated across 3 untrained conditions: metastatic tumors, precancerous lesions, and age stratified data. The results demonstrate that CancerNet performs well across all stages of cancer and is robust to age related epigenetic drift.

### Metastasis and Precancerous Lesions

Metastatic cancer is the cause of death in 66% of hard tumor cases.²⁸ The identification of a second cancer occurrence as a metastatic or second primary tumor is important to inform treatment. In rare cases carcinogens of unknown primary are also found. These tumors arise as metastasis of a previously undiscovered primary tumor²⁹. Detecting tissue of origin in both of these scenarios can assist in critical treatment decisions. We demonstrate that CancerNet is capable of robust and highly accurate metastatic tissue of origin (TOO) classification and this performance is maintained in early cancer samples as well.

To assess performance on metastasis we first predicted TOO for metastatic samples present in TCGA for BRCA, CESC, COAD, HNSC, PAAD, PCPG, PRAD, SARC, SKCM, THCA. The TOO for all metastatic cancers were predicted with an overall unweighted F-measure of 91%.

TCGA data were processed by the same labs and so it is possible that uninformative variance in noise could be introduced due to small but predictable variance in human error, reagent preparation or some other part of the sample processing pipeline. This is known as batch effect. Batch effect can provide a source of information about sample classes that, if learned, could make the model brittle in real world applications where the same effect is not present. We used several GEO datasets to assess whether this was the case and further validate the model on non-TCGA derived data. These datasets also gave us the opportunity to test CancerNets performance on cancer stages that were not present in TCGA data such as precancerous lesion which, along with primary and metastatic and recurrent samples, provide an assessment of CancerNets performance across all stages of cancer for several tissues and cancer types.

The first dataset (GEO accession: GSE58999) contained paired metastatic and primary tumors in breast cancer patients. CancerNet achieved an unweighted F-measure of 99% on this dataset. The second dataset (GEO accession: GSE113019) contained triplets of liver samples from each patient, namely, non-tumorous, primary tumor and recurrent samples. CancerNet achieved an unweighted f-measure of 100% for all primary tumors, 100% on metastatic samples and 85% for the normal samples.

The final dataset (GEO accession: GSE67116) consisted of 96 uterine samples which were stratified across cancer stages with precancerous endometrial hyperplasia, primary tumor and metastasis represented in addition to two cell lines. Samples were harvested from various tissue sites within the uterus. Because endometrial hyperplasia increases a patient's risk of developing uterine cancer by 30%³⁰ we chose to label these samples as cancer. CancerNet achieved an unweighted f-measure of 85% on this dataset.

Hyperplasia samples performed the worst with an unweighted f-measure of 66%. On all other sites CancerNet achieved a 92% unweighted f-measure. This indicates that CancerNet may be capable of cancer prediction when no cancer is present. However, there is not data on cancer progression for the patients who had endometrial hyperplasia in this dataset.

To assess the predictive capability of CancerNet we used a dataset (GEO accession #: GSE66313 derived from 55 precancerous ductal carcinoma in situ samples. 40 of these samples later developed malignant forms of breast cancer. CancerNet identified the “future” cancer samples (40 of 55) with an unweighted f-measure of approximately 91% and “non-future” cancer samples (15 of 55) with an unweighted f-measure of approximately 66%, demonstrating that the model is capable of not only detecting cancer and it's tissue of origin but has a reasonably high level of predictive capacity for pre-cancers as well without being explicitly trained to do so.

Strong results in both the metastatic and normal categories demonstrate that the model has learned reliable cancer signatures and is capable of tissue of origin detection in cancers that have undergone metastasis. The use of precancerous lesions in CancerNet does not fall neatly under the classification task for which CancerNet was trained as it is a predictive task. Due to the transitional nature of precancerous lesions they could be classified as normal tissue, which they are, or predicted as cancerous, which they may become. The performance of CancerNet of precancerous samples is promising and it most likely the result of the latent space prior for the classification task. If more precancerous samples for which the progression is known are made available then it is possible that a predictive task could be added to the model and trained for that specific task. Together the performance across the cancer spectrum is consistent and demonstrates the robustness of CancerNet.

### Age-Related Methylation Drift

Age-related CpG methylation drift is the normal global hypomethylation associated with aging²⁹.

Some cancer etiologies may be associated with age-related methylation drift^{29,31}. CancerNet may be classifying based on background age-related methylation drift rather than methylation changes relevant to carcinogenesis. To verify that this was not the case we used a dataset (GEO accession #: GSE113904) 232 age-stratified normal colon tissue samples. Samples were from individuals of age ranging from 29 to 81 years. CancerNet classified all of these samples correctly as normal regardless of age.

### Discussion

Here we developed and validated an end-to-end unified neural network method for diagnosing multiple cancers. We achieved state-of-the-art performance through all cancer stages with robustness to possible confounding factors such as age. Though exemplary methods as provided herein do not include brain or blood tumors it is reasonable to believe that those tumors can be successfully included in future versions of the model.

Where efforts have been made to focus on tissue-of-origin detection, some studies, surprisingly, have done so without determining whether a sample is cancerous or not. Without non-cancerous classes incorporated within a model framework, the model may actually learn tissue specific signatures due to the retention of cell specific methylation signatures even in carcinogenesis. This approach may thus lead to a model learning normal tissue signatures rather than cancer signatures. Therefore, it is pertinent to include normal samples to allow the model to learn to discriminate between normal tissue specific signatures and tumor tissue specific signatures. We therefore have taken due diligence to include normal samples in CancerNet training and classification and ensured that CancerNet's performance is not an artifact of tissue specific signatures. CancerNet is thus endowed with the ability to robustly diagnose cancer and detect the cancer tissue of origin as well. This was demonstrated by performing assessment on different datasets and comparing with two different tools, CancerLocator and RF model, designed to perform similar task.

Robust tissue level classification is a huge step forward for early cancer detection. Indeed, many cancers have no early diagnostic whatsoever. The clinical use of such a model will benefit from inclusion of information about tumor evolution and tumor subtypes. Such information would aid in treatment decisions and prognosis determination. It is our belief that clinical diagnostic is not the only significant use of such a model. Research in cancer biology may be aided by investigating the learned features in the model's latent space. Such features may illuminate complex interactions between multiple mutations and methylation dysregulation in a given cellular context. This could provide valuable information about new drug targets. The value of this information coming from a unified model cannot be understated as it provides the opportunity to find potential targets present in multiple cancers and subdivide tumors in feature space rather than in anatomical space allowing discernment of yet unknown aspects of the tumor microenvironment and its effects on oncogenic pathways by way of epigenetics.

Detecting cancer in asymptomatic patients or screening population for cancers requires minimally invasive procedures. Current methods of screening body fluids for biomarkers have been proposed for use with circulating cell-free DNA, cfDNA.³²⁻³⁵ Several studies have shown that methylation persists on the fragments of circulating tumor DNA (ctDNA) and is stable enough to provide cancer diagnosis and tissue of origin classification.³⁶⁻⁴⁰ Several key steps must be taken to adapt CancerNet for use with ctDNA. Primarily the number of CpG islands present in a sample at different stages must be assessed. If the model relies on far more features than can feasibly be found in a typical sample, then the model must be adapted to that reality. Additionally, circulating cfDNA may come from multiple sources. Presumably the majority of DNA fragments could come from cells such as macrophages or other normal tissues with good access to the blood that are turned over at a fair rate. Filtering samples to identify the ctDNA fragments of interest is a necessary preprocessing step. We expect technological advances in cfDNA processing will make possible non-invasive, robust early diagnosis of cancers and tissue of origin determination using emerging tools from the field of artificial intelligence such as the exemplary methods as provided herein, or CancerNet.

### Methods

### Methylation Data

Illumina 450™ methylation array data were downloaded from The Cancer Genome Atlas (TCGA) GDC portal for all cancer types. Metastatic and recurrent samples were removed. This resulted in total 13,325 samples. Each sample was labeled by its tissue of origin and TCGA cancer type designation. Rather than creating classes for each normal tissue all samples that were from non cancerous tissue were included in the normal class. This was done due to the extremely low numbers of normal samples available for some tissue types. Additional validation sample sets were downloaded from NCBI Gene Expression Omnibus (GEO). Details of specific GEO datasets used are provided in Supplementary Table 1.

### Data Preparation

We relied on the CpG density clustering approach implemented in CancerLocator to process the methylation data before inputting to CancerNet.¹⁷ Specifically, the methylation data was scanned for Illumina 450 probes that map to within 100 bp of each other, which were then concatenated. These clusters were then filtered to eliminate those with 3 CpGs or less.¹⁷ The beta values of the resulting clusters were then averaged. This resulted in 24,565 clusters that map to CpG islands. These average beta values were used as input to CancerNet. The dataset was then randomly split into training/test/validation sets with 80% in training set and 10% in test and validation sets each. We ensured that the training set did not include more than one sample per patient by removing one of any matched pairs present in the dataset and replacing it with a random sample from the same class.

### Performance

Held-out test data from TCGA and other GEO datasets were used to assess CancerNet's performance measured in terms of recall, precision, and F-measure. For a specific class (e.g. a cancer tissue of origin or normal), recall defines the fraction of samples belonging to this class that are correctly identified by a classification method. Precision is the fraction of predictions for this class that are correct, and F-measure is the harmonic mean of recall and precision. Unless otherwise enoted the performance measure presented in this work is weighted f measure. The f1 score function present in the sci-kit learn python library was used to calculate this.

### Neural Network

The CancerNet model was written in Python using the keras package with a tensorflow backbone. The neural network architecture of CancerNet consists of an encoder, decoder and classifier. The encoder has an input layer of 24565 that is fully connected to a dense layer of 1000 nodes that uses a relu nonlinearity and the two dense activation free layers that are passed to the probabilistic layer, also called the latent layer, characteristic of VAE architectures which has 100 nodes. The decoder has a single dense layer of 1000 nodes that uses a relu activation and if fully connected to the output layer which is 24565 nodes and uses a sigmoid activation. The classifier takes the layer as input to a dense 100 node layer that uses a relu activation which is fully connected to the classifier output which has 34 nodes and uses a softmax activation. The architecture is shown in FIG. 7. CancerNet was trained using the Adam optimizer with a learning rate of 0.001. All layers were randomly initialized and then trained until convergence. Early stopping was used to limit training time and prevent overfitting and was limited to 50 epochs without validation accuracy improvement. The final loss of the network was the sum of the VAE loss and the categorical cross-entropy loss which are applied to the generative output and the classification output respectively.

VAE loss is composed of two terms. The first term quantifies the divergence between the output of the generator and the input to the model using categorical cross-entropy. The second term is used to enforce gaussian distributions in the latent layer by calculating the Kullbeck-Leibler divergence of the encoders' distribution and a standard normal. The VAE loss beta term can be used to create a disentangled VAE. When beta is greater than one, features are forced to disentangle and become easier to interpret. Beta is set to 1 in CancerNet.

Cross entropy is applied to the classifier output and calculates a loss based on the difference between the classifier output and the class labels. This is not to be confused with the cross entropy portion of the VAE loss which calculates a loss on the generative output and the sample itself. The generator and classification loss together enforce the latent space representation of samples to preserve information about samples' natural distribution while also creating an easily classifiable distribution of samples. In doing so the latent space acts as a prior in the classifier.

### Prevention of Leakage

Leakage is a phenomenon in machine learning where information about the task is inadvertently added to the data on which the task is being performed⁴¹. This can lead to very brittle models or even completely useless models when used outside the test and training data. Tasks such as normalizing datasets prior to splitting into training/testing/validation sets can introduce information present in the test and validation sets into the training set artificially inflating the performance of the model in validation and test phases⁴¹. The beta values of the Illumina 450k array were normalized on a sample by sample basis and bounded in the range [0, 1] preventing information from crossing among samples. The validation set is then used as a sanity check to confirm the model performance on unseen data. We also demonstrate further that the model is robust by using independent datasets from GEO.

### Figure Captions

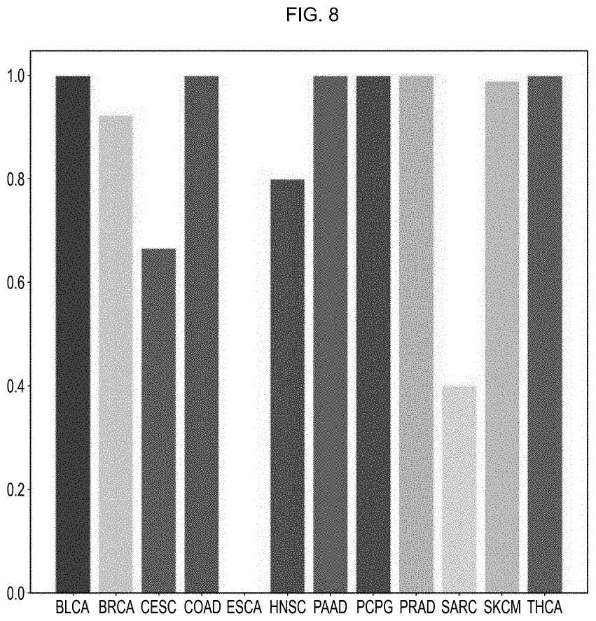

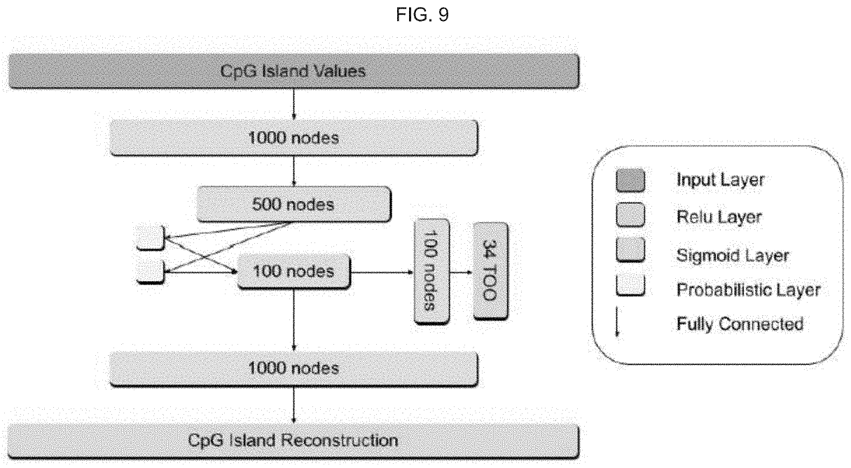

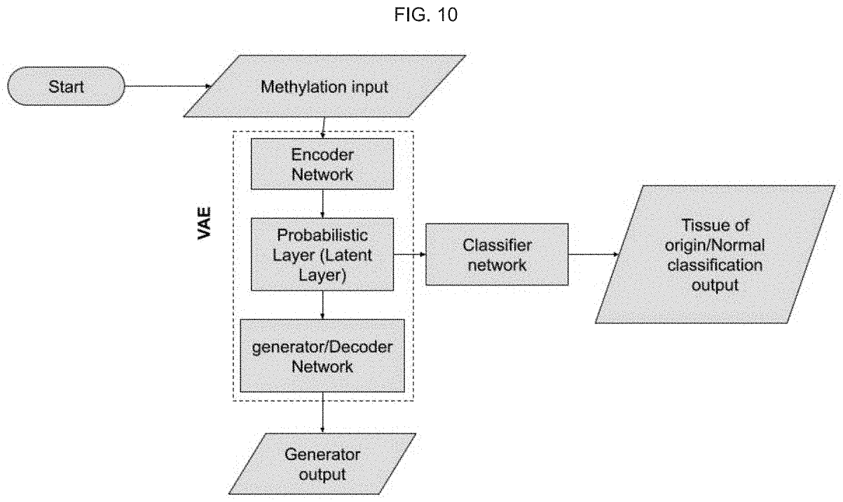

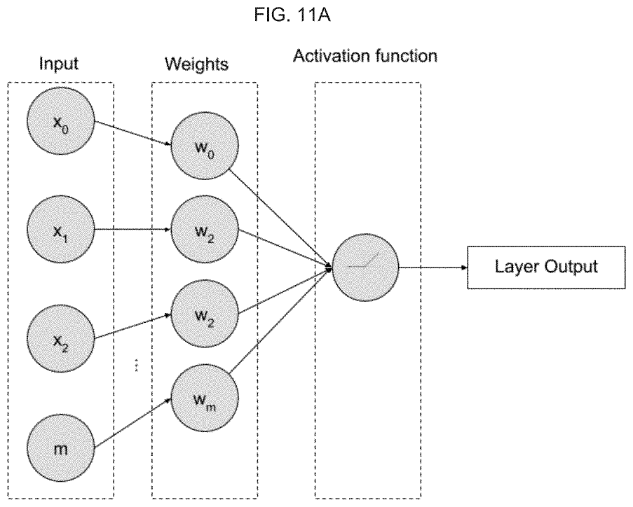

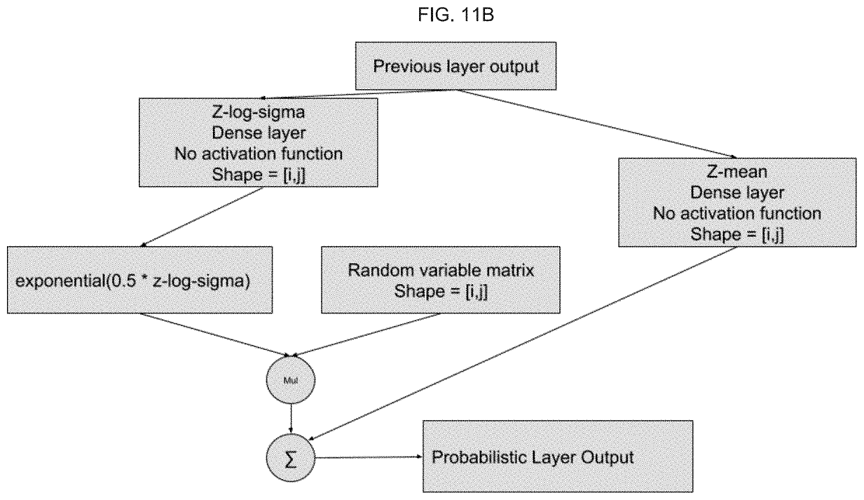

FIG. 3. Performance Evaluation of CancerNet on TCGA Data
Performance of CancerNet over all 19 classes. Performance was assessed using the accuracy metric F-measure. Accuracy averaged over 19 classes is 96.4%. Column colors represent TCGA tissue of origin.
Classification of READ (left) and COAD (right) samples.
Classification of UCEC and UCS. READ: Rectum Adenocarcinoma; COAD: Colon Adenocarcinoma; LUAD: Lung Adenocarcinoma; UCS: Uterine Carcinosarcoma; UCEC: Uterine Corpus Endometrial Carcinoma; BRCA: Breast Carcinoma; OV: Ovarian serous cystadenocarcinoma.
FIG. 4. Visualization of Test Samples in the Latent Space
T-SNE was used to reduce the latent space dimension from 100 to 2. Samples originating from the same tissue form groups and are close to sample groups of similar tissues. Those tissues that commonly misclassify among each other, such as UCS/UCES and COAD/READ, appear intermingled in the latent space. For abbreviations, refer to the full abbreviation list. Normal samples are abbreviated NORM and are displayed in gray.
FIG. 5. Clustering of Cancers Based on Feature Importance Scores
Feature importance scores were generated using integrated gradients method with a black basis for the classifier output. Feature importance scores for samples of each class were averaged and those average class feature importance scores were clustered. Proximal classes in this hierarchical clustering map may misclassify among themselves more often.
FIG. 6 illustrates: Gastric Adenocarcinoma latent space distribution. Gastric Adenocarcinaomas in the latent space cluster together by A. Body site of tumor and B. Hypomethylation status
FIG. 7 illustrates Squamous cell carcinoma samples latent space distribution. Squamous cell carcinomas tend to cluster together among their tissue of origin and the A. by HPV status but not by B. Smoker status in methylation data in CancerNet FIG. 8 illustrates Metastatic Performance. Metastastic performance for metastatic samples in TCGA.
FIG. 9: A. Diagram of basic dense feedforward layer. An input tensor is multiplied by a weight matrix which is in turn input in a elementwise fashion to an activation function. The output is then passed to the next layer. B. Diagram of probabilistic layer of the VAE. The output from a previous layer is input and passed to two activation free layers called z-mean and z-sigmoid. Z-sigmoid is multiplied by 0.5 and passed to an exponential function). The output is multiplied by a randomly generated matrix of the same size as z-mean. This is then summed with z-mean and output.
FIG. 10 illustrates a flow.diagram of CancerNet. Methylation data is input to the encoder. The encoder is composed of two dense feedforward layers (from A) using the Relu activation function. Output of the encoder is passed to the probabilistic layer (from B) which passes its output to the classifier and generator/decoder. The classifier is two dense feed forward layers the first with the ReLu activation function the second with the softmax activation function. The decoder is two dense feed forward layers the first using the Relu activation and the second using the sigmoid activation function.

### Abbreviations:

ACC—Adrenocortical carcinoma, BLCA—Bladder Urothelial Carcinoma, BRCA—Breast invasive carcinoma, CESC—Cervical squamous cell carcinoma and endocervical adenocarcinoma, CHOL—Cholangiocarcinoma, COAD—Colon adenocarcinoma, DLBC—Lymphoid Neoplasm Diffuse Large B-cell Lymphoma, ESCA—Esophageal carcinoma, GBM—Glioblastoma multiforme, HNSC—Head and Neck squamous cell carcinoma, KICH—Kidney Chromophobe, KIRC—Kidney renal clear cell carcinoma, KIRP—Kidney renal papillary cell carcinoma, LAML—Acute Myeloid Leukemia, LCML—Chronic Myelogenous Leukemia, LGG—Brain Lower Grade Glioma, LIHC—Liver hepatocellular carcinoma, LUAD—Lung adenocarcinoma, LUSC—Lung squamous cell carcinoma, MESO—Mesothelioma, NORM—Normal (non-cancer), OV—Ovarian serous cystadenocarcinoma, PAAD—Pancreatic adenocarcinoma, PCPG—Pheochromocytoma and Paraganglioma, PRAD—Prostate adenocarcinoma, READ—Rectum adenocarcinoma, SARC—Sarcoma, SKCM—Skin Cutaneous Melanoma, STAD—Stomach adenocarcinoma, TGCT—Testicular Germ Cell Tumors, THCA—Thyroid carcinoma, THYM—Thymoma, UCEC—Uterine Corpus Endometrial Carcinoma, UCS—Uterine Carcinosarcoma, UVM—Uveal Melanoma

### Citations

1. Howlader N, Noone A M, Krapcho M, Miller D, Brest A, Yu M, Ruhl J, Tatalovich Z, Mariotto A, Lewis D R, Chen H S, Feuer E J, Cronin K A (eds). SEER cancer statistics review, 1975-2017. https://seer.cancer.gov/csr/1975_2017/. Updated 2020.
2. Yang Z, Jones A, Widschwendter M, Teschendorff A E. An integrative pan-cancer-wide analysis of epigenetic enzymes reveals universal patterns of epigenomic deregulation in cancer. Genome Biol. 2015; 16(1):140.
3. Lokk K, Modhukur V, Rajashekar B, et al. DNA methylome profiling of human tissues identifies global and tissue-specific methylation patterns. Genome Biol. 2014; 15(4):3248.
4. Salas L A, Wiencke J K, Koestler D C, Zhang Z, Christensen B C, Kelsey K T. Tracing human stem cell lineage during development using DNA methylation. Genome Res. 2018; 28(9):1285-1295.
5. Sahnane N, Magnoli F, Bernasconi B, et al. Aberrant DNA methylation profiles of inherited and sporadic colorectal cancer. Clinical epigenetics. 2015; 7(1):131.
6. Ross J P, Rand K N, Molloy P L. Hypomethylation of repeated DNA sequences in cancer. Epigenomics. 2010; 2(2):245-269. https://doi.org/10.2217/epi.10.2. doi: 10.2217/epi.10.2.
7. Lee S, Wiemels J L. Genome-wide CpG island methylation and intergenic demethylation propensities vary among different tumor sites. Nucleic Acids Res. 2016; 44(3):1105-1117.
8. Liggett T E, Melnikov A, Yi Q, et al. Distinctive DNA methylation patterns of cell-free plasma DNA in women with malignant ovarian tumors. Gynecol Oncol. 2011; 120(1):113-120.
9. Stefansson O A, Moran S, Gomez A, et al. A DNA methylation-based definition of biologically distinct breast cancer subtypes. Molecular oncology. 2015; 9(3):555-568.
10. Bormann F, Rodríguez-Paredes M, Lasitschka F, et al. Cell-of-origin DNA methylation signatures are maintained during colorectal carcinogenesis. Cell reports. 2018; 23(11):3407-3418.
11. Capper D, Jones D T, Sill M, et al. DNA methylation-based classification of central nervous system tumours. Nature. 2018; 555(7697):469-474.
12. Mundbjerg K, Chopra S, Alemozaffar M, et al. Identifying aggressive prostate cancer foci using a DNA methylation classifier. Genome Biol. 2017; 18(1):1-15.
13. Robles A I, Arai E, Mathé E A, et al. An integrated prognostic classifier for stage I lung adenocarcinoma based on mRNA, microRNA, and DNA methylation biomarkers. Journal of Thoracic Oncology. 2015; 10(7):1037-1048.
14. Brentnall A R, Vasiljević N, Scibior-Bentkowska D, et al. A DNA methylation classifier of cervical precancer based on human papillomavirus and human genes. International journal of cancer. 2014; 135(6):1425-1432.
15. Melnikov A A, Scholtens D M, Wiley E L, Khan S A, Levenson V V. Array-based multiplex analysis of DNA methylation in breast cancer tissues. The Journal of Molecular Diagnostics. 2008; 10(1):93-101.
16. Tang W, Wan S, Yang Z, Teschendorff A E, Zou Q. Tumor origin detection with tissue-specific miRNA and DNA methylation markers. Bioinformatics. 2018; 34(3):398-406.
17. Kang S, Li Q, Chen Q, et al. CancerLocator: Non-invasive cancer diagnosis and tissue-of-origin prediction using methylation profiles of cell-free DNA. Genome Biol. 2017; 18(1):1-12.
18. Hoadley K A, Yau C, Hinoue T, et al. Cell-of-origin patterns dominate the molecular classification of 10,000 tumors from 33 types of cancer. Cell. 2018; 173(2):291-304. e6.
19. Way G P, Greene C S. Extracting a biologically relevant latent space from cancer transcriptomes with variational autoencoders. BioRxiv. 2017:174474.
20. Amodio M, Van Dijk D, Srinivasan K, et al. Exploring single-cell data with deep multitasking neural networks. Nature methods. 2019:1-7.
21. Taroni J N, Grayson P C, Hu Q, et al. MultiPLIER: A transfer learning framework for transcriptomics reveals systemic features of rare disease. Cell systems. 2019; 8(5):380-394. e4.
22. Wang Z, Wang Y. Extracting a biologically latent space of lung cancer epigenetics with variational autoencoders. BMC Bioinformatics. 2019; 20(18):1-7.
23. Ronen J, Hayat S, Akalin A. Evaluation of colorectal cancer subtypes and cell lines using deep learning. Life science alliance. 2019; 2(6).

24. Kingma D P, Welling M. Auto-encoding variational bayes. arXiv preprint arXiv:1312.6114. 2013.
25. Goodfellow I, Pouget-Abadie J, Mirza M, et al. Generative adversarial nets. 2014:2672-2680.
26. Davis C F, Ricketts C J, Wang M, et al. The somatic genomic landscape of chromophobe renal cell carcinoma. Cancer cell. 2014; 26(3):319-330.
27. Campbell J D, Yau C, Bowlby R, et al. Genomic, pathway network, and immunologic features distinguishing squamous carcinomas. Cell reports. 2018; 23(1):194-212. e6.
28. Dillekås H, Rogers M S, Straume O. Are 90% of deaths from cancer caused by metastases? Cancer medicine. 2019; 8(12):5574-5576.
29. Moran S, Martinez-Cardús A, Boussios S, Esteller M. Precision medicine based on epigenomics: The paradigm of carcinoma of unknown primary. Nature Reviews Clinical Oncology. 2017; 14(11):682.
30. Lacey Jr J V, Chia V M. Endometrial hyperplasia and the risk of progression to carcinoma. Maturitas. 2009; 63(1):39-44.
31. Ehrlich M. DNA methylation in cancer: Too much, but also too little. Oncogene. 2002; 21(35):5400-5413.
32. van der Heijden, Antoine G, Mengual L, Ingelmo-Torres M, et al. Urine cell-based DNA methylation classifier for monitoring bladder cancer. Clinical epigenetics. 2018; 10(1):71.
33. Viet C T, Schmidt B L. Methylation array analysis of preoperative and postoperative saliva DNA in oral cancer patients. Cancer Epidemiology and Prevention Biomarkers. 2008; 17(12):3603-3611.
34. Heitzer E, Ulz P, Geigl J B. Circulating tumor DNA as a liquid biopsy for cancer. Clin Chem. 2015; 61(1):112-123.
35. Sun K, Jiang P, Chan K A, et al. Plasma DNA tissue mapping by genome-wide methylation sequencing for noninvasive prenatal, cancer, and transplantation assessments. Proceedings of the National Academy of Sciences. 2015; 112(40):E5503-E5512.
36. Diehl F, Schmidt K, Choti M A, et al. Circulating mutant DNA to assess tumor dynamics. Nat Med. 2008; 14(9):985-990.
37. Bettegowda C, Sausen M, Leary R J, et al. Detection of circulating tumor DNA in early-and late-stage human malignancies. Science translational medicine. 2014; 6(224):224ra24.
38. Teschendorff A E, Menon U, Gentry-Maharaj A, et al. An epigenetic signature in peripheral blood predicts active ovarian cancer. PloS one. 2009; 4(12):e8274.
39. Shen S Y, Singhania R, Fehringer G, et al. Sensitive tumour detection and classification using plasma cell-free DNA methylomes. Nature. 2018; 563(7732):579-583.
40. Chan K A, Jiang P, Chan C W, et al. Noninvasive detection of cancer-associated genome-wide hypomethylation and copy number aberrations by plasma DNA bisulfate sequencing. Proceedings of the National Academy of Sciences. 2013; 110(47):18761-18768.
41. Kaufman S, Rosset S, Perlich C, Stitelman O. Leakage in data mining: Formulation, detection, and avoidance. ACM Transactions on Knowledge Discovery from Data (TKDD). 2012; 6(4):1-21.

A number of embodiments of the invention have been described. Nevertheless, it can be understood that various modifications may be made without departing from the spirit and scope of the invention. Accordingly, other embodiments are within the scope of the following claims.

What is claimed is:

1. A computer-implemented method for detecting and classifying cancers comprising: a computer-implemented method comprising a sub set of, substantially all, or all of the steps as set forth in the flow chart of FIG. 10.

2. A computer program product for processing data, the computer program product comprising: computer-executable logic contained on a computer-readable medium (optionally a non-transitory computer-readable medium) and configured for causing the following computer-executed steps to occur: executing the computer-implemented method of claim 1.

3. A Graphical User Interface (GUI) computer program product comprising: program instructions for running, processing and/or implementing: (a) a computer-implemented method of claim 1; (b) a computer program product of claim 2.

4. A computer system comprising a processor and a data storage device wherein said data storage device has stored thereon: (a) a computer-implemented method of claim 1; (b) a computer program product of claim 2; (c) a Graphical User Interface (GUI) computer program product of claim 3; or, (d) a combination thereof.

5. A non-transitory memory medium, or a comprising program instructions for running, processing and/or implementing: (a) a computer-implemented method of claim 1; (b) a computer program product of claim 2; (c) a Graphical User Interface (GUI) computer program product of claim 3; (d) a computer system of claim 4; or (e) a combination thereof.

6. A non-transitory computer readable medium storing an executable program comprising instructions to perform a method claim 1; (b) a computer program product of claim 2; (c) a Graphical User Interface (GUI) computer program product of claim 3; (d) a computer system of claim 4; or (e) a combination thereof.

7. A method for diagnosing a cancer comprising use of a computer-implemented method for detecting and classifying cancers as set forth in claim 1.

8. The method of claim 6, wherein the cancer is Adrenocortical carcinoma (ACC), Bladder Urothelial Carcinoma (BLCA), Breast invasive carcinoma (BRCA), Cervical squamous cell carcinoma and endocervical adenocarcinoma (CESC), Cholangiocarcinoma (CHOL), Colon adenocarcinoma (COAD), Lymphoid Neoplasm Diffuse Large B-cell Lymphoma (DLBC), Esophageal carcinoma (ESCA), Glioblastoma multiforme (GBM), Head and Neck squamous cell carcinoma (HNSC), Kidney Chromophobe (KICH), Kidney renal clear cell carcinoma (KIRC), Kidney renal papillary cell carcinoma (KIRP), Acute Myeloid Leukemia (LAML), Chronic Myelogenous Leukemia (LCML), Brain Lower Grade Glioma (LGG), Liver hepatocellular carcinoma (LIHC), Lung adenocarcinoma (LUAD), Lung squamous cell carcinoma (LUSC), Mesothelioma (MESO), Ovarian serous cystadenocarcinoma (OV), Pancreatic adenocarcinoma (PAAD), Pheochromocytoma and Paraganglioma (PCPG), Prostate adenocarcinoma (PRAD), Rectum adenocarcinoma (READ), Sarcoma (SARC), Skin Cutaneous Melanoma (SKCM), Stomach adenocarcinoma (STAD), Testicular Germ Cell Tumors (TGCT), Thyroid carcinoma (THCA), Thymoma (THYM), Uterine Corpus Endometrial Carcinoma (UCEC), Uterine Carcinosarcoma (UCS), or Uveal Melanoma (UVM).

9. A method for treating a cancer comprising use of a computer-implemented method for detecting and classifying cancers as set forth in claim 1, wherein the method comprises: (a) using the computer-implemented method for detecting and classifying a cancer in an individual in need thereof, and (b) treating the detected and classified cancer.

10. The method of claim 8, wherein the cancer is Adrenocortical carcinoma (ACC), Bladder Urothelial Carcinoma (BLCA), Breast invasive carcinoma (BRCA), Cervical squamous cell carcinoma and endocervical adenocarcinoma (CESC), Cholangiocarcinoma (CHOL), Colon adenocarcinoma (COAD), Lymphoid Neoplasm Diffuse Large B-cell Lymphoma (DLBC), Esophageal carcinoma (ESCA), Glioblastoma multiforme (GBM), Head and Neck squamous cell carcinoma (HNSC), Kidney Chromophobe (KICH), Kidney renal clear cell carcinoma (KIRC), Kidney renal papillary cell carcinoma (KIRP), Acute Myeloid Leukemia (LAML), Chronic Myelogenous Leukemia (LCML), Brain Lower Grade Glioma (LGG), Liver hepatocellular carcinoma (LIHC), Lung adenocarcinoma (LUAD), Lung squamous cell carcinoma (LUSC), Mesothelioma (MESO), Ovarian serous cystadenocarcinoma (OV), Pancreatic adenocarcinoma (PAAD), Pheochromocytoma and Paraganglioma (PCPG), Prostate adenocarcinoma (PRAD), Rectum adenocarcinoma (READ), Sarcoma (SARC), Skin Cutaneous Melanoma (SKCM), Stomach adenocarcinoma (STAD), Testicular Germ Cell Tumors (TGCT), Thyroid carcinoma (THCA), Thymoma (THYM), Uterine Corpus Endometrial Carcinoma (UCEC), Uterine Carcinosarcoma (UCS), or Uveal Melanoma (UVM).
